(19) United States
(12) Patent Application Publication
(10) Pub. No.: US 2002/0075708 A1
(43) Pub. Date: Jun. 20, 2002

(54) Power supply having rectifier and shunt circuit

(76) Inventors: Arjan Van Den Berg, Nijmegen (NL); Hendrikus Johannes Janssen, Nijmegen (NL); Maarten Jacobus Swanenberg, Nijmegen (NL)

Correspondence Address: U.S. Philips Corporation, 580 White Plains Road, Tarrytown, NY, 10591, US

(21) Appl. No.: 09/992,710

(22) Filed: Nov. 6, 2001

(30) Foreign Application Priority Data
Nov. 8, 2000 (EP) 00203926.1

(51) Int. Cl. H02M 7/00

(52) U.S. Cl. 363/125

(57) ABSTRACT

A power supply (10), comprising a rectifier (2) having an input side (3) connectable to an AC main power supply and an output side (6) connectable to a load; and a controllable shunt switch circuit (12), wherein the shunt switch circuit (12) is arranged on the input side (3) of the rectifier (2) to selectively shunt the rectifier (2) via the output side thereof.

The present invention relates to a power supply, comprising a rectifier having an input side connectable to an AC main power supply and an output side connectable to a load; and a controllable shunt switch circuit.

Power supplies for low power level applications are commonly known and are used for instance in appliances, which can be brought into a standby mode. In such a standby mode, low power dissipation is desired.

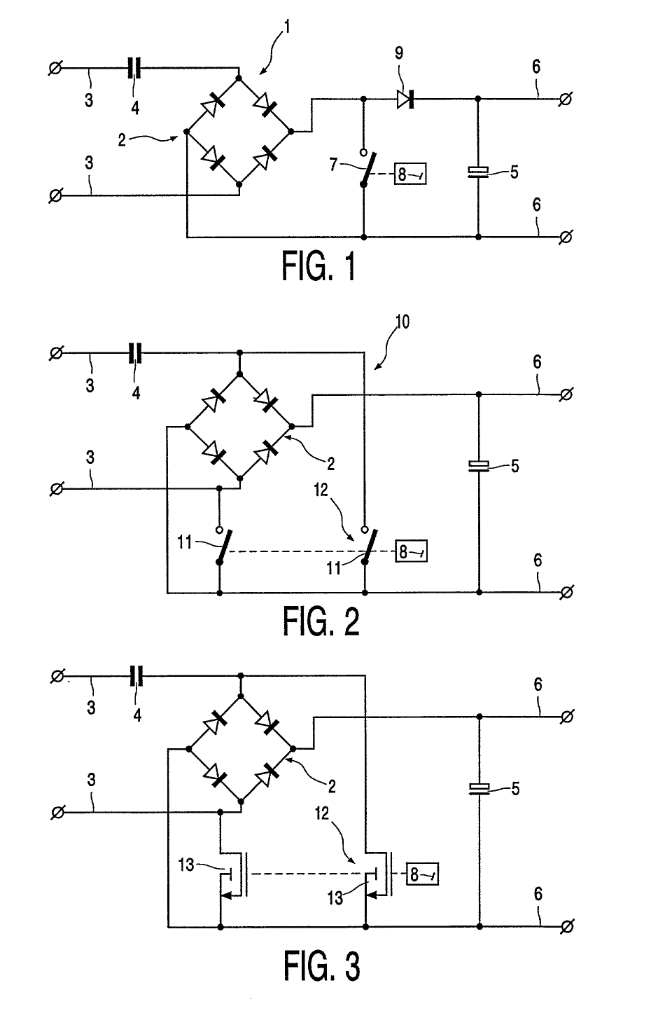

In a specific prior art power supply, which is described here below in relation to FIG. 1, a switch circuit 7 is arranged parallel over an output side of a rectifier 2. In practice also a diode 9 will be provided between the rectifier 2 and a load capacitor 5, which diode 9 will be oriented such, that discharge of the capacitor 5 is prevented. Such a prior art configuration has for a disadvantage, that power dissipation is high as a result of current from the AC main power supply continues to flow through the rectifier 1, often a full wave diode bridge circuit.

From EP-A-0,891,039 a power supply is known, in which the rectifier comprises a full wave diode bridge circuit and the switch circuit is arranged to shunt the load capacitor selectively through the rectifier. Thus, in a standby mode, power will continue to be dissipated within the rectifier.

From U.S. Pat. No. 3,355,650 a power supply is known, which has for a disadvantage, that the switch circuit is a floating device and difficult to control as a result thereof, because control signals for the switch circuit are to be derived from the load side.

An object of the present invention is to provide a power supply, where power dissipation is minimised. A further object of the present invention is to provide a power supply, comprising a minimum number of components. Yet another object of the present invention is to provide a power supply, wherein control of the switch circuit thereof is facilitated. To this end, the invention provides a power supply as defined in the independent claim. Advantageous embodiments are defined in the dependent claims.

According to the present invention a power supply is provided, whereby these objects are achieved and the problems of known power supplies are, for the intended applications, solved or at least lessened, to which end the power supply of the invention distinguishes itself over the known power supplies in that the switch circuit is arranged on the input side of the rectifier to selectively shunt the rectifier via the output side thereof.

In a power supply according to the present invention power dissipation in a standby mode or other low power level application is minimised, as no current from the AC main power supply flows through the rectifier, which is, in its entirety, shunted when desired, i.e. in the standby mode. Further, according to the present invention, control of the switch circuit is simplified or facilitated, since no floating devices are used; the switch circuit has a relationship to a reference potential at the output side of the rectifier. Further, especially when a full wave diode bridge rectifier is used, a supplementary diode to prevent discharge of the load capacitor is superfluous, thus minimising the number of components required.

Although a single switch can be used to shunt the rectifier and provide a connection to the output side thereof to facilitate control, in one embodiment of the present invention the switch circuit comprises a pair of switches, which are on the one hand respectively connected to the separate one of two input connectors to the rectifier on the input side thereof and which are both on the other hand connected to one of two output connectors from the rectifier on the output side thereof. Although an additional component is introduced in such an embodiment, simultaneous control of two switches in the switch circuit thus configured can result in specific advantages, such as integration in a single chip, etc. As switchers the switch circuit can comprise at least one switch transistor. Especially when such a transistor is a NMOS transistor implementation in VLSI is facilitated.

In a specific embodiment one of the connectors to the rectifier on the input side thereof comprises a substantially non-dissipating passive electrical component in series. The presence of such a passive component here not merely serves to adjust the input power level to the rectifier, but is necessary in order not to short-circuit the AC main power supply. Such a non-dissipating passive electrical component preferably comprises a capacitor. In order to be able to drive the switch circuit according to the present invention, a power supply preferably comprises a control circuit, to which the switch circuit is connected for selective switching of the switch circuit.

The features, advantages and other aspects of the present invention will be elucidated here below in the non-restrictive description of specific embodiments of the present invention under reference to the accompanying drawings, in which:

FIG. 1 shows a configuration according to prior art;

FIG. 2 shows a configuration of a power supply in a first embodiment of the present invention; and

FIG. 3 shows an implementation of the configuration of FIG. 2.

FIG. 1 shows a configuration of a power supply for low power level applications according to prior art. The power supply 1 comprises a rectifier 2, which has the configuration of a full wave diode bridge circuit and which rectifier 2 is connectable via connectors 3 to an AC main power supply, which is not shown. The AC main power supply is for instance the mains power supply, which usually has a voltage level of 110 or 220 volts. The input voltage over the rectifier 2 is adjusted with a capacitor 4. At the output side thereof, the right side in FIG. 1, the rectifier provides a rectified power to a load, which is not shown.

Parallel over the output side of the rectifier 2, a load capacitor 5 is arranged between connectors 6 at the output side of the rectifier 2.

Also parallel over the output side of the rectifier 2, a shunt switch 7 is arranged, which is controlled by a control circuit 8.

In the non-conductive state of the switch 7, the load capacitor 5 is charged. Once sufficient charge is collected in the load capacitor, the control 8 of the switch 7 closes switch 7. In this state the load is for instance in a standby mode and remains inoperative, until the control 8 again opens the switch 7, so that power can be provided to the load. A suitably arranged diode 9 prevents discharge of the load capacitor 5 in the conductive state of the switch 7.

In the conductive state of switch 7, the amount of power used by the supply circuit 1 is determined by the current from the AC main power supply through connectors 3, the voltage drop over the rectifier 2, and the voltage drop over the shunt switch 7. In the embodiment shown here the power loss can be expressed as P=2×VD×I+I×R₇. In this expression V_{D} is the voltage drop over one of the diodes in the rectifier 2 and R₇ is an indication for the value of the resistance of switch 7 in the conductive state thereof. Further I is an indication for the current from the AC main power supply, which is determined by the capacitance of capacitor 4 and the voltage level provided by the AC main power supply.

FIGS. 2 and 3 show an embodiment of a power supply 10 according to the present application. In this embodiment, schematically represented in FIG. 2, a switch circuit 12 comprising two switches 11 is provided, where the switches 11 are under the control of a control circuit 8, which functions in a similar manner as the control circuit 8 of FIG. 1. FIG. 3 shows a practical implementation, wherein for switches 11 NMOS transistors 13 are applied. Such an embodiment is highly advantageous, since the embodiment according to FIG. 3 can be realised in an integrated form in a VLSI design.

Referring back to FIG. 2, the switches 11 are, on the one hand, each connected to a separate one of the connectors 3 to the rectifier 2 on the input side thereof, while on the other hand, both switches 11 are connected to a single one of the connectors 6 on the output side of the rectifier 2. Said one of the connectors 6 is the reference connector, which is usually grounded. Since the switches 11 are thus connected, their function will be determined in relation to the ground potential, which facilitates control by the control circuit 8.

Under control of the control circuit 8 both switches 11 can be brought in a conductive state, i.e. closed, as a result of which the rectifier 2 is completely bypassed, together with the load capacitor 5. In the conductive state of the switches 11 and in an embodiment of the rectifier 2 as a full wave diode bridge circuit, as is shown in FIG. 2, one of the diodes of the rectifier 2 prevents discharge of the load capacitor 5. Thus the number of components used or required for the power supply 10 is optimised.

Assuming that for the switches 1 the same switches are used as switch 7 in FIG. 2, the power loss can now be expressed as P=2×I²×R₁₁=2×I²×R₇. Thus, relative to a configuration according to FIG. 1, a substantial decrease in the power loss is achieved in the amount of 2×V_{D}×I−I²×R₇ Assuming that I=70 mA, that the voltage drop over a diode in the rectifier 2 V_{D}=0.75 V, and that the resistance of a shunt switch in the conductive state thereof R₇=4 ohm, then the power loss in FIG. 1 is 125 mW, whereas in the configuration according to FIG. 2 the power loss is 39 mW. Especially for applications where a low standby power is desired, such a difference is considerable. Moreover, a further improvement in the power loss can be achieved by scaling the resistance of the switches 11 in the conductive state thereof, as is apparent from the formula above. In contrast, scaling of this resistance R₇ in FIG. 1 results in only a minor decrease in the power loss.

Arrangement of the switches 11 in FIG. 2 on the input side of the rectifier 2 to shunt the rectifier 2 in its entirety, together with the load capacitor 5, therefore results in extremely low power loss. As described above, the switches 11 shunt or bypass the rectifier 2 via the reference connector 6, usually connected to ground potential, which facilitates control over the switches 11 by the control circuit 8, as the switches 11 are no floating devices, but can be controlled reliably as a result of this shunt configuration via the reference connector 6.

A further advantage of the configuration of FIGS. 2 and 3 is that for control of the switches 11, 13 the principle of zero voltage switching (ZVS) can be applied. This entails, that the switches 11 are switched on when the voltage thereover is zero. As a result the switch losses are minimised. According to the prior art, as depicted in FIG. 1, zero voltage switching cannot be applied directly, because the voltage on the anode of diode 9 will never be zero volts, whereas the voltage over the switches 11, 13 follows the input voltage over the connectors 3, which will be zero volt regularly, i.e. with the frequency of the voltage supplied by the AC main power supply.

Based on the description above, a person skilled in the art will readily realise that many additional and alternative embodiments of the present invention are possible, which additional and alternative embodiments are all considered lying within the scope of the present invention, as defined in the accompanying claims. It is for instance possible to apply a single switch under control of a control circuit, together forming a switch circuit, where such a single switch has three contacts, two of which are connected to the connectors on the input side of the rectifier, while a third contact of such a three-way switch is in contact with the connector on the output side of the rectifier, which is a reference for this output side and is for instance connected to ground. Further, another configuration of a rectifier can be applied. Also the power supply according to the present invention can be applied in many devices or appliances, such as televisions, radios, etc. in which a standby mode function is provided and where in a standby mode power losses should be as low as possible.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In a device claim enumerating several means, several of these means can be embodied by one and the same item of hardware. The mere fact that certain measures are recited in mutually different dependent claims does not indicate that a combination of these measures cannot be used to advantage.

1. A power supply (10), comprising:
a rectifier (2) having an input side (3) connectable to an AC main power supply and an output side (6) connectable to a load; and
a controllable shunt switch circuit (12), wherein the shunt switch circuit (12) is arranged on the input side (3) of the rectifier (2) to selectively shunt the rectifier (2) via the output side thereof.

2. Power supply (10) according to claim 1, wherein the shunt switch circuit (12) comprises a pair of switches, which are on the one hand respectively connected to a separate one of two input connectors to the rectifier (2) on the input side (3) thereof and which are both on the other hand connected to one of two output connectors from the rectifier on the output side (6) thereof.

3. Power supply according to claim 2, wherein said one of two output connectors from the rectifier (2) on the output side (6) thereof is connected to ground.

4. Power supply according to claim 1, wherein the switch circuit (12) comprises at least one switch transistor (13).

5. Power supply according to claim 4, wherein said at least one transistor is an NMOS transistor (13).

6. Power supply according to claim 1, wherein one of the connectors to the rectifier (2) on the input side (3) thereof comprises a substantially non-dissipating passive electrical component (4) in series.

7. Power supply according to claim 6, wherein said substantially non-dissipating passive electrical component comprises a capacitor (4).

8. Power supply according to claim 1, wherein the switch circuit is connected to a control circuit (8) for selective switching the switch circuit (12).
